(19) United States
(12) Patent Application Publication
(10) Pub. No.: US 2026/0111259 A1
(43) Pub. Date: Apr. 23, 2026

(54) GENETIC ALGORITHM WITH DETERMINISTIC LOGIC FOR MULTI-RESOURCES FOR SINGLE TASKS

(71) Applicant: nMetric, LLC, Dallas, TX (US)

(72) Inventors: Christine Koski, Dallas, TX (US); Stephen Cook, Albuquerque, NM (US)

(21) Appl. No.: 18/921,781

(22) Filed: Oct. 21, 2024

(51) Int. Cl. G06F 9/48; G06N 3/126

(52) U.S. Cl. CPC G06F 9/4881; G06N 3/126

(57) ABSTRACT

A system and method for a using a genetic algorithm with an extra bit in the genome to obtain a best-fit of resource combinations for a particular task to be scheduled. The system can generate a genome from a plurality of jobs and then add an extra bit that can be used to find the best resource combination in the event that multiple resource combinations are equally suitable as an initial fit.

### FIELD OF THE INVENTION

The field of the invention is computer-based scheduling systems.

### BACKGROUND

The background description includes information that may be useful in understanding the present invention. It is not an admission that any of the information provided herein is prior art or relevant to the presently claimed invention, or that any publication specifically or implicitly referenced is prior art.

Sometimes, a task requires multiple resources that must be simultaneously scheduled. Unfortunately, for all of the advances made in this field, current systems do not provide a solution for this problem. Existing systems, for example, cannot determine what might be the lead resource from the available resources for a given task.

Thus, there is still a need for systems and methods that can efficiently generate a schedule and enable its implementation when multiple resources are needed for the tasks to be scheduled.

### SUMMARY OF THE INVENTION

The inventive subject matter provides apparatus, systems and methods in which a system includes one or more computing devices. The system can be programmed to arrange a genome from a plurality of tasks corresponding to a plurality of jobs. The system then generates an extra bit, which it appends to the genome.

The system then obtains a plurality of real-world requirements for a plurality of resources within a particular task within the plurality of tasks within the genome, as well as a starting estimate for a best-fit resource for the task from the plurality of resources. The system then searches for a primary resource combination from the plurality of resources based on the starting estimate.

The system then uses a genetic algorithm to search for a primary resource combination and determines the primary resource combination based on the resources found during the search and the extra bit. The resources within the determined primary resource combination are assigned to the task and a schedule is generated with the task and the assigned resource.

In embodiments of the inventive subject matter, the starting estimate is based on a combination heuristic.

In embodiments of the inventive subject matter, the task requires multiple resources concurrently.

In embodiments of the inventive subject matter, the computing device is programmed to weigh initial values and mutations based on past scoring.

In embodiments of the inventive subject matter, the determination of a primary resource combination is based on a predefined criteria.

Various objects, features, aspects and advantages of the inventive subject matter will become more apparent from the following detailed description of preferred embodiments, along with the accompanying drawing figures in which like numerals represent like components.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### BRIEF DESCRIPTION OF THE DRAWING

FIG. 1 provides a flowchart illustrating the processes executed by a computing device, according to embodiments of the inventive subject matter.

FIGS. 2A and 2B are an example of an assembly of a genome.

FIG. 3 illustrates the genome that includes the added extra bit.

### DETAILED DESCRIPTION

Throughout the following discussion, numerous references will be made regarding servers, services, interfaces, engines, modules, clients, peers, portals, platforms, or other systems formed from computing devices. It should be appreciated that the use of such terms, is deemed to represent one or more computing devices having at least one processor (e.g., ASIC, FPGA, DSP, x86, ARM, ColdFire, GPU, multi-core processors, etc.) programmed to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

A computer-based scheduling system can account for one or more types of scheduling problems that can be based on factors such as the type of organization, the type of jobs and/or tasks involved, available times, etc. Some examples of the types of scheduling problems these systems are expected to handle include:

Open shop scheduling. In open shop scheduling, each job has a task on each available machine, without any types of ordering constraints. Thus, the tasks can be performed in any order. Typically, there's no parallel work on a job.

Flow shop scheduling: In flow shop scheduling, each job has a task on each machine. Unlike open shop scheduling, the order of the tasks matters in flow shop scheduling.

Permutation flow shop: Permutation flow ship is similar to flow shop scheduling, but the machine must perform the jobs (and the tasks therein) in the same order.

Job shop (“JSP”) scheduling, also known as Job-Shop Scheduling Problem (“JSSP”): the goal for JSP is to minimize “makespan”. This means that the goal for JSP is to compress the schedule as much as possible.

Flexible job shop (“FJSP”) scheduling: This is similar to the job shop scheduling, but the resources are interchangeable.

Truthful job scheduling: The resources available can perform any task in the job, but they take different time. For example, the resources can include personnel that have different skill levels at performing the task.

One challenge that computer-implemented scheduling systems face is that schedule generation for many jobs having many tasks is an “NP-hard” problem. For example, an open shop scheduling problem with “n” jobs and “m” resources has (n!)^{m} possible combinations. For 10 jobs with 10 resources, that means 3.95*10⁶⁵ possible schedules.

While scheduling types with more restrictions have a lower potential amount of schedules, the combinations are still staggering and simply too many for a computer system to brute force a “best” schedule.

Current systems use simple heuristic deterministic scheduling algorithms:

R (Random)—Pick any Job in Queue with equal probability. This rule is often used as benchmark for other rules

FCFS (First Come First Serve)—Jobs are processed in the order in which they arrived at the work center (also called earliest release date)

SPT (Shortest Processing Time)—This rule tends to reduce both work-in-process inventory, the average job completion (flow) time, and average job lateness. SPT can also be used to break ties.

EDD (Earliest Due Date)—Choose Job that has earliest due date

CR (Critical Ratio)=Processing Time/Time until due (Due Date−Current Time). Take the highest value.

LWR (Least Work Remaining)—This rule is an extension of SPT variant that considers the number of successive operations

ST (Slack Time)=Time until job is due−(Sum of processing time remaining). Take the job with the smallest amount of slack time.

ST/O (Slack Time per Remaining Operation)=slack time divided by number of operations remaining. Take the job with the smallest amount of slack time per remaining Operation.

Existing systems have also employed more “complex” scheduling heuristics, such as Johnson's Algorithm (that uses Bellman-Ford), Kusiak's Algorithm, Palmer's Algorithm, Gupta's Algorithm, Shifting Bottleneck Algorithm, Campbell-Dudek-Smith (“CDS”) Algorithm, and/or Nawas-Enscore-Ham (“NEH”) Algorithm.

However, for the most part these all simply employ variations and/or combinations of the simple heuristics. While these approaches may get acceptable results in a human-scale amount of time, none are guaranteed to find optimal solutions.

Existing scheduling systems employ fitness functions that use common variables such as processing time, release date, due date, weight, lateness, makespan, and release date. Common fitness functions will then return “raw” fitness scores that can be combined with user-supplied specific factors to weight the fitness scores. For example, an output of the fitness function can be a measure of robustness, which reflects the sensitivity of the schedule to problems/interruptions in a flow. Typically, to improve robustness, a system can add idle times, schedule less flexible jobs first, and forward-schedule as many tasks as possible. In another example, the output of the fitness function can be a measure of tightness, which minimizes the absolute size of the lateness.

As discussed herein a job is made up of tasks. Tasks are discrete functions or processes that are the subparts of a job. The tasks of a job are often sequential such that one or more tasks may need to be completed for a subsequent one or more tasks of a job to start.

A task requires one or more resources to complete. A resource can be anything that a task may need to be completed. Examples of resources can include equipment, personnel, locations, etc.

A genome as discussed herein can be considered to be a list of tasks. In the examples discussed herein, a genome can include all of the tasks from all of the jobs associated with an organization or a process within an organization.

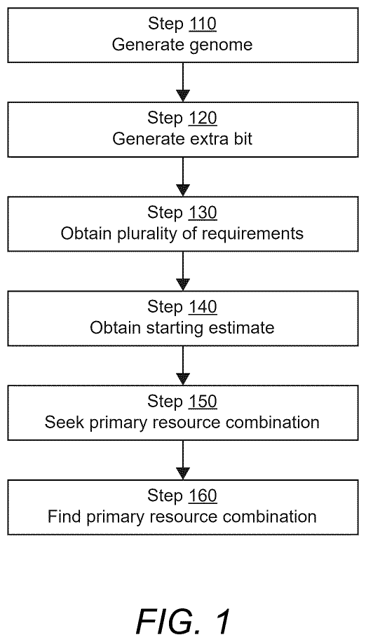

FIG. 1 provides a flowchart illustrating the processes executed by a computing device, according to embodiments of the inventive subject matter.

At step 110, the computing device arranges a genome from a plurality of jobs, each of the jobs containing a plurality of tasks.

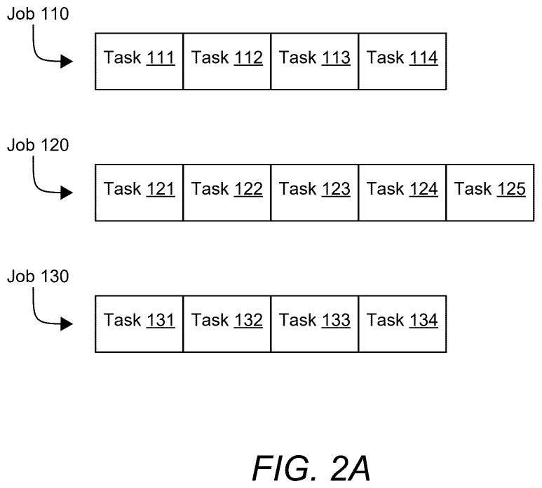

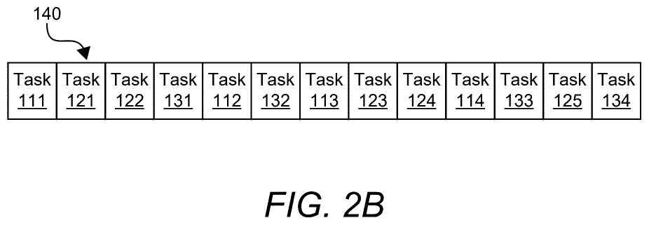

An example of the assembly of a genome is seen in FIGS. 2A and 2B.

FIG. 2A illustrates a plurality of jobs 210, 220, 230 with their respective tasks organized sequentially according to the job. Thus, job 210 will have task 1 (block 211), task 2 (block 212), task 3 (block 213) and task 4 (block 214) that need to be performed for the job 210 to be completed. Likewise, job 220 has tasks 1-5 (blocks 221-225, respectively) and job 230 has tasks 1-4 (blocks 231-234, respectively).

To create a genome, the computing device gets all of the tasks associated with all of the jobs and mixes them up to create a list from all of these tasks. FIG. 2B shows an example of a genome created from all of the tasks of jobs 210, 220 and 230. Generally speaking the tasks can be mixed up in almost any order, though the assembly of a genome can be subject to rules. For example, one rule of a genome is that the tasks must be for any job along the length of the genome. This means that while the tasks of a genome are not required to be consecutive or next to one another, a task for a job cannot precede an earlier task from the same job. Thus, in this example, task 3 (block 213) of job 210 cannot be before task 2 (block 212) of the same job 210 within an assembled genome.

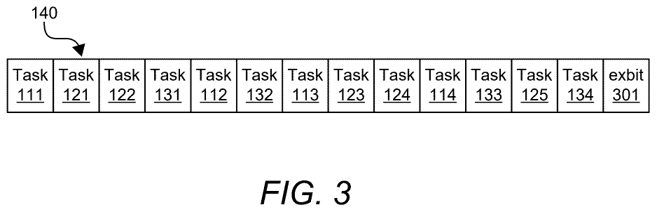

At step 120, the computing device generates an extra bit within the generated genome. FIG. 3 illustrates the gene with the extra bit 301 (shown as “exbit 301”) added to the genome.

This extra bit can be an extra deterministic logic bit that is used by the computing device to determine which preference to have when scheduling tasks having multiple resource requirements. Different task-resource combinations might have a same or similar “fitness score”, and since the “mathematical/consistency requirement” requires that the same genome produces the same schedule (i.e., is repeatable), then the system needs a deterministic method to choose the preference order for all possible combinations. The extra bit enables the computing device to do so.

In embodiments of the inventive subject matter, the additional bit comprises an additional gene value that stores or is a pointer to a specific decision algorithm stored by the computing device or elsewhere that is accessible by the computing device. The specific decision algorithm is applied by the computing device to decide which task-resource combinations take precedence so that there is never a “tie”. This way, the computing device will always determine a specific “winning” task-resource combination.

At step 130, the computing device obtains a plurality of real-world requirements for a plurality of resources required for a task within the plurality of tasks (across the plurality of jobs) within the genome.

In embodiments of the inventive subject matter, the task can require the use of multiple resources from the plurality of resources. For example, a particular task can require the use of a particular machine and require particular raw materials or inputs for the machine. In a surgery setting, this can include multiple machines in a surgery room and certain supplies (e.g., anesthesia, bandages, tools, etc.).

At step 140, the computing device obtains a starting estimate for a best-fit resource from the plurality of resources for the task.

In embodiments of the inventive subject matter, the starting estimate is based on a combination heuristic. The starting estimate based on the combination heuristic can, for example, be a “lead” resource. The lead resource could be a resource that is most important to a particular task, or a resource with a most limited availability among all resources. In another example, the combination heuristic can generate the starting estimate based on one or more of the most available resources.

At step 150, the computing device searches, via the use of a genetic algorithm, for a primary resource combination from the plurality of resources based on the starting estimate obtained at step 140.

The primary resource combination can be considered to be the best fit combination of resources for a particular task given the starting estimate and other factors. A suitable way to determine a best-fit combination of resources for a task is in applicant's own work as described in U.S. Ser. No. 17/332,906 titled Genetic Algorithm with Deterministic Logic, issued on May 7, 2024 as U.S. Pat. No. 11,977,988, which is hereby incorporated by reference in its entirety.

In embodiments of the inventive subject matter, the computing device can build the primary resource combination off a most restrictive resource. The most restrictive resource is a resource among the plurality of resources that is “hardest” to schedule. This may be based on a limited availability (due to scheduling, due to a limited number of machines available, etc.). In these embodiments, the computing device obtains attributes associated with each resource. The attributes can include information such as a resource's current schedule, how many/much of the resource are available (e.g., how many total machines of this type), hours of operation of the resource, flexibility of scheduling, mobility of the resource (e.g., is the resource mobile or fixed to a location), etc. Based on these attributes across the plurality of resources, the computing device determines which resource is the most restrictive resource. The computing device then assigns the most restrictive resource as the lead resource/best-fit resource, building out the combination of resource to account for the limitations of the most restrictive resource.

At step 160, the computing device then determines the primary resource combination among the plurality of resources for the task based on the outcome of the genetic algorithm and the extra bit generated at step 120.

In embodiments of the inventive subject matter, the computing device can determine the primary resource combination based on a predefined criteria.

In embodiments of the inventive subject matter, the computing device is programmed to weigh initial values and mutation values based on past scoring.

In embodiments of the inventive subject matter, the computing device can determine, from attributes associated with each of the plurality of resources, a resource as a most restrictive resource. The most restrictive resource can be a resource that is hardest to schedule—because it is the most rare, most expensive, furthest away, etc. The attributes in each resource can include location, amount, cost, availability, etc. and from these resources the computing device can determine a most restrictive resource. The most restrictive resource can be an overall most restrictive resource out of all resources. In other embodiments, the most restrictive resource can be by category or resource type—so there may be multiple designated “most restrictive resource”.

Following a determination of the most restrictive resource, the computing device assigns the most restrictive resource as a lead resource and groups the lead resource within the primary resource combination.

In certain situations, there may be more than one primary resource combination with an equal or similar “fitness score.” In these embodiments, the computing device looks to the extra bit.

The extra bit can, in embodiments, comprise a decision algorithm that the computing device uses to decide which resource combinations take precedence. In embodiments, the extra bit can include a pointer to a storage location (either within the computing device or at a different network location) for the decision algorithm that the computing device can access.

The use of real-world requirements of resources as an influencing factor for the genome improves over prior systems by assisting the genome in arriving at a determination faster with less randomness. This makes the process more computationally-efficient, resulting in less waste of computing resources.

The system including the computing device then uses the primary resource combination to generate a schedule for the tasks and the resources in the genome. Within the generation of the schedule, the computing device can include sending instructions to one or more of the resources according to the schedule. The instructions can include an unlock instruction at a particular point in time corresponding to the schedule, an initiation instruction that initiates a resource (e.g., a machine) for preparation for the use of the resource in the task, etc.

To generate the schedule, the computing device can, in embodiments, assign the resources within the primary resource combination to the task and then add the task to a schedule. The task can be added based on one or more of the attributes associated with the resource(s) assigned to the task such as availability, supply, etc.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system for applying a genetic algorithm with deterministic logic for multi-resources required for a single task, comprising a processor programmed to:
arrange a genome from a plurality of tasks corresponding to a plurality of jobs;
generate an extra bit within the genome;
obtain, by the processor, a plurality of real-world requirements for a plurality of resources within a task from the plurality of tasks within the genome;
obtain, by the processor, a starting estimate for a best-fit resource from the plurality of resources;
search, by the processor and via the genetic algorithm, for a primary resource combination from the plurality of resources based on the starting estimate;
determine, by the processor, the primary resource combination among a plurality of resources based on the outcome of the genetic algorithm and the extra bit;
assign the resources within the primary resource combination to the task; and
generate a schedule including the task and the assigned resources.

2. The system of claim 1, wherein the starting estimate is based on a combination heuristic.

3. The system of claim 1, wherein the task requires using multiple resources from the plurality of resources concurrently.

4. The system of claim 1, wherein the processor is further programmed to weight initial values and mutation values based on past scoring.

5. The system of claim 1, wherein the determination of the primary resource combination is based on a predefined criteria.

6. The system of claim 1, wherein the processor is further programmed to:
determine, from attributes associated with each of the plurality of resources, a resource as a most restrictive resource;
assign the most restrictive resource as the lead resource from the plurality of resources; and
group the lead resource within the primary resource combination.
